(19) United States
(12) Patent Application Publication
(10) Pub. No.: US 2016/0104385 A1
(43) Pub. Date: Apr. 14, 2016

(54) BEHAVIOR RECOGNITION AND ANALYSIS DEVICE AND METHODS EMPLOYED THEREOF

(71) Applicants: Maqsood Alam, Murphy, TX (US); Muzammil Alam, Hyderabad (IN)

(72) Inventors: Maqsood Alam, Murphy, TX (US); Muzammil Alam, Hyderabad (IN)

(21) Appl. No.: 14/509,075

(22) Filed: Oct. 8, 2014

(51) Int. Cl. G09B 5/00

(52) U.S. Cl. CPC G09B 5/00

(57) ABSTRACT

Exemplary embodiment of the present disclosure are directed towards behavior recognition and analysis device and methods employed thereof The device including one or more capturing units configured to capture behavior recognition movements of students accompanied in a specified area to detect emotions expresses by each individual student. The expressed motions detected based on the plurality of facial features collected from the students. One or more physical activity monitoring units configured to monitor bodily movements for determining a temporary state of mind of the each individual student accompanied in the specified area, an emotion extraction unit extracts the data conveyed by the respective emotions expressed by the students and recognize a specific student expressing an emotion by comparing the predetermined data collected from. the students and the image capturing unit by an image recognition unit to provide an emotional quotient and academic impact report of each individual student to the user.

### TECHNICAL FIELD

The present disclosure generally relates to a field of behavior recognition systems and methods, More particularly, the present disclosure relates to a device and methods employed for analyzing behavior.

### BACKGROUND

Generally, psychologists pay little attention to emotions expressed by individuals. At different stages, the behaviorist tradition and the subsequent cognitive movement both underplayed the importance of emotions, mainly because they were not directly observable.

Generally, psychologists tended to view them as possible obstructions to people making good decisions and focusing on tasks. Further the direction of thinking has been changed that people can build emotional strength, making emotions pertinent to education. Thus the emotions, which were previously regarded as irrational and inexplicable, were conceived as being rational and related to logic and understanding. Later conception allowed emotions to be organized and shaped to convey valuable information and enhance cognitive processes

Today it is recognized that aspects of cognition is mainly focused on schooling such as for learning, attention, memory, decision making, motivation and social functioning are not only affected by emotion but intertwined within emotion processes. In addition, application of knowledge, facts and logical reasoning skills learnt at school to real world situations requires emotion processes. The new directions in thinking about emotions have contributed to a greater understanding of student and teacher experiences of emotion and, in particular, an enhanced knowledge of how emotion can be regulated. Thus it is recognized that the emotions observed from students may enhance the way of teaching.

In the light of aforementioned discussion there exists a need of a device and method for analyzing behavior of children.

### BRIEF SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

A more complete appreciation of the present disclosure and the scope thereof can be obtained from the accompanying drawings which are briefly summarized below and the following detailed description of the presently preferred embodiments.

An exemplary objective of the present disclosure is to build a customized system used to analyze behaviors of students in a classroom.

Another exemplary objective of the present disclosure is to provide an emotion quotient analysis of a student based on the detected facial expressions and body movements.

Also another exemplary objective of the present disclosure is to compare the academic performance and churn out comparative studies between analyzed facial expressions and body movements.

Exemplary embodiments of the present disclosure are directed towards to a device for analyzing behavior, According to a first aspect, the device includes one or more capturing units configured to capture behavior recognition movements of one or more students accompanied in a specified area to detect one or more body movements of each individual student. The emotions expressed are detected based on the plurality of body features collected from the one or more students.

According to an exemplary aspect, the device includes one or more physical activity monitoring units configured to monitor one or more bodily movements for determining a temporary state of mind of each individual student accompanied in the specified area.

According to an exemplary aspect, the device includes an emotion extraction unit configured extract the data conveyed by the one or more behavior recognition movements expressed by the one or more students to further modify the expression of the one or more students based on the interest of the each individual student.

According to an exemplary aspect, the device includes an image recognition unit configured to recognize a specific student expressing one or more behavior recognition movements by comparing with the predetermined data collected from the one or more students; and the image capturing unit.

According to an exemplary aspect, the device includes data repository unit configured to store credentials of the one or more students along with the one or more behavior recognition movements expressed by the each individual student within a specific period of time.

According to an exemplary aspect, the device includes reporting and integration unit configured to report the emotional quotient and academic impact of each individual student to the user by analyzing the one or more behavior recognition movements extracted from the one or more students.

The above summary relates to only one of the many embodiments of the invention disclosed herein and is not intended to limit the scope of the invention, which is set forth in the claims herein. These and other features of the present invention will be described in more detail below in the detailed description of the invention and in conjunction with the following figures.

### BRIEF DESCRIPTION OF DRAWINGS

Other objects and advantages of the present invention will become apparent to those skilled in the art upon reading the following detailed description of the preferred embodiments, in conjunction with the accompanying drawings, wherein like reference numerals have been used to designate like elements, and wherein:

FIG. 1 is diagram depicting a device used for detecting behavior recognition movements, in accordance with exemplary embodiments of the present disclosure.

FIG. 2 is a block diagram depicting behavior recognition movement's capturing device in communication with a server, in accordance with exemplary embodiments of the present disclosure.

FIG. 3 is a flow chart depicting a method for analyzing behavior recognition movements of the human body in accordance with exemplary embodiments of the present disclosure.

FIG. 4 is a flow chart depicting a method of recognizing a sad emotion, in accordance with exemplary embodiments of the present disclosure.

FIG. 5 is a flow diagram depicting a method of recognizing a happy emotion, in accordance with exemplary embodiments of the present disclosure.

FIG. 6 is a flow diagram depicting a method of recognizing a surprise emotion, in accordance with exemplary embodiments of the present disclosure.

### DETAIL DESCRIPTION

It is to be understood that the present disclosure is not limited in its application to the details of construction and the arrangement of components set forth in the following description or illustrated in the drawings. The present disclosure is capable of other embodiments and of being practiced or of being carried out in various ways, Also, it is to be understood that the phraseology and terminology used herein is for the purpose of description and should not be regarded as limiting.

The use of “including”, “comprising” or “having” and variations thereof herein is meant to encompass the items listed thereafter and equivalents thereof as well as additional items. The terms “a” and an herein do not denote a limitation of quantity but rather denote the presence of at least one of the referenced item. Further, the use of terms “first”, “second”, and “third”, and the like, herein do not denote any order, quantity, or importance, but rather are used to distinguish one element from another.

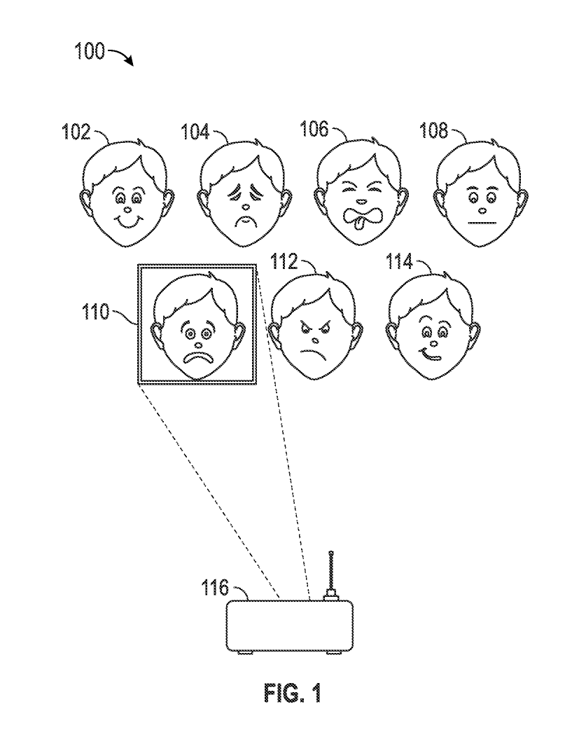

FIG. 1 is a diagram 100 depicting a device used for analyzing behavior recognition movements. According to non limiting exemplary embodiment of the present disclosure, the behavior recognition capturing device 116 positioned in a room used to capture behavior recognition movements of the students accompanied in a specified room. For convenience the present disclosure discusses only about a method of using the behavior recognition movements capturing device 116 in a. classroom. However it should be understood that in practice the behavior recognition movements capturing device 116 can be used in any gathering room as similar as classroom that can be included in the disclosure.

As shown in FIG. 1, the behavior recognition movements capturing device 116 used to detect the behavior recognition movements of the students in classrooms. The detected behavior recognition movements but not limited to happy 102, disgust 104, sad 106, calm 108, fear 110, anger 112 and surprise 114 and the like. Here the behavior recognition movements may include but not limited to hand moments, body movements, hand and leg movements, lip movements, and body postures and the like. For example, if the detected behavior recognition movement is fear 110, the device extracts the detected feelings recognize movements to know the specified feeling to the respective emotion of the student and modify the way of teaching or required changes to be adapted to remove the fear from the respective student. Similarly the different emotions expressed by the multiple students in the classroom are detected and an emotion quotient and academic impact of that particular student is analyzed to further provide an enhanced way of teaching based on the emotions expressed by the students.

Further as shown in FIG. 1, the behavior recognition capturing device 116 is also used to monitor bodily movements of the students in the classroom for determining a temporary state of mind of the each individual student. For example, if the head position of the student does not move, eyes does not blink and neutral expressions, these behavior recognition movements represents that the particular student concentrating on the lecture or teaching subject. The behavior recognition movements may include but not limited to head position, eye blinks and the like without limiting the scope of the disclosure. The number of eye blinks made by an each individual student by comparing with the predefined data of the student for detecting autism, concentration span, and the like of the respective student. Also the emotion of a specified student is recorded by a random selection based on the number of availabilities of the respective student in a physical activity monitoring unit.

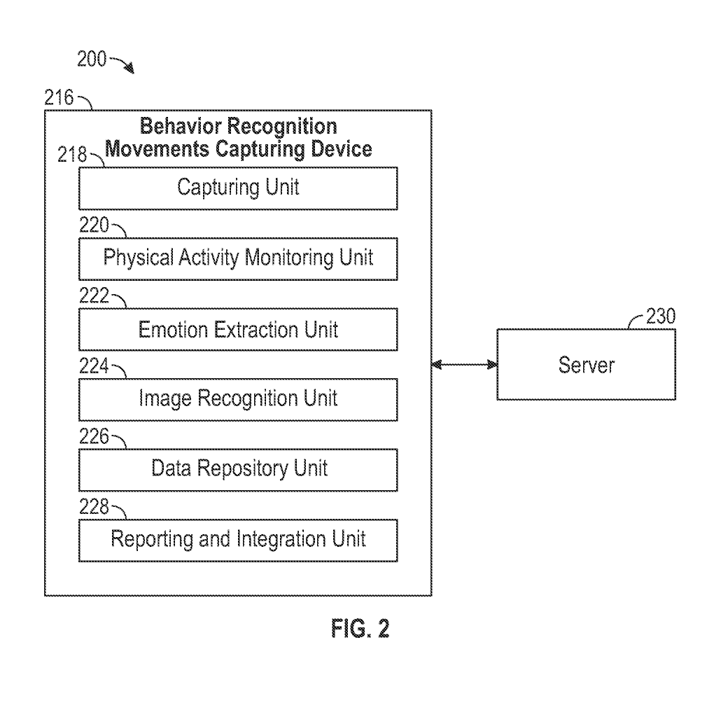

FIG. 2 is a block diagram 200 depicting behavior recognition movements capturing device in communication with a server. According to a non limiting exemplary embodiment of the present disclosure, the behavior recognition movements capturing device 216 is used to recognize the behaviors of multiple students accompanied in a specified room which may include but not limited to a. classroom, tutorial, schoolroom, teaching room, and the like. The behavior recognition movements capturing device 216 may include but not limited to a portable device, mobile phone, tablet, personal computer, and the like, used to interact with the students through a wireless communication network.

As shown in FIG. 2, the behavior recognition movements capturing device 216 includes a capturing unit 218 configured to capture behavior recognition movements of the multiple students accompanied in a classroom, For convenience the present disclosure discuss about only one capturing unit 218. However it should be understood that in practice there may be any number of in a classroom as similar as the capturing unit 218 that can be included in the disclosure. Also based on the requirement of the user, the respective capturing unit 218 projecting towards the specified student can be selected for collecting the behavior recognition movements of the respective student. The capturing unit 218 may include but not limited to camera, robotic camera, camera with pan and zoom, Google glass, camera fitted on glasses and the like.

Also as shown in FIG. 2, for example, the students accompanied in a classroom express multiple body features for the teachings heard from a teacher. The images of behavior recognition movements of the capturing unit 218 are used to detect the respective behavior recognition movements movement expressed by the each individual student based on the various facial features collected from the images of the students for a predetermined period of time. A physical activity monitoring unit 220 may configured to monitor the bodily movements of the students in the classroom for determining a temporary state of mind of the each individual student, The bodily movements may include but not limited to head. position, eye blinks and the like without limiting the scope of the disclosure. The behavior recognition movements capturing device 216 may use the captured emotions by the capturing unit 218 and monitor bodily movements by physical activity monitoring unit 220 for identifying the behavior of the particular student, The behavior of the student may be determined by the captured behavior recognition movements, monitored physical activity combination of both, isolation of captured data, and the like, without limiting the scope of the disclosure.

As shown in FIG, 2, the captured behavior recognition movements may identified by the physical activity monitoring unit 220 which may be included in the feelings recognize move behavior recognition movements capturing device 216 based on the behavior recognition movements expressed by the students in the specific period of time. The physical activity monitoring unit 220 is also used to track the number of eye blinks made by the each individual student and compare with the predefined data collected from the student for detecting autism of the respective student and concentration span, and the like of the respective student. The physical activity monitoring unit 220 may include but not limited to 3D depth sensing camera, and the like.

Further as shown in FIG. 2, the time tracked by the physical activity monitoring unit 220 configured to provide a specific time slice for the emotion collected from the students, such as for example from the total detected time of 240 minutes, the time slice is divided for each individual emotion i.e., the happy emotion of student is carried for 45 minutes and remaining 18 minutes is carried with a sad emotion. Similarly any emotion carried by the student in a predefined period of time is detected, Further, an emotion extraction unit 222 included in the behavior recognition movements capturing device 216 configured to extract the respective feeling conveyed through the captured behavior recognition movements of the students. The extracted behavior recognition movements conveys the feeling of the students along with the time period of that particular emotion carried by the student by calculating the emotion extracted time with the total detected time.

Also further as shown in FIG. 2, the behavior recognition movements capturing device 216 also includes an image recognition unit 224 to recognize a specific student expressing behavior recognition movements by comparing with the predetermined data collected from the students through the capturing unit 218 and the physical activity monitoring unit 220. Also further a data repository unit 226 configured to store the credentials of the students along with the multiple behavior recognition movements expressed by the each individual student within a specific period of time, Further a reporting and integration unit 228 included in the behavior recognition movements capturing device 216 configured Co report the emotional quotient and academic impact of each individual student to the user by analyzing the behavior recognition movements extracted from the students.

Moreover as shown in FIG. 2, the emotion quotient may include but not limited to trend analysis, percentile analysis, benchmark analysis, peer-group comparative analysis, and the like, calculated for comparing the emotion extracted time with the total detected time. For example if the total extracted time is 240 minutes and the respective happy emotion extracted time is 45 minutes then the emotion quotient is 18%. Also the academic impact is calculated by comparing the academic performance and churn out meaningful comparative studies between emotions and academic excellence, Further the data received by the behavior recognition device 216 is updated in a server 230 for a predetermined period of time.

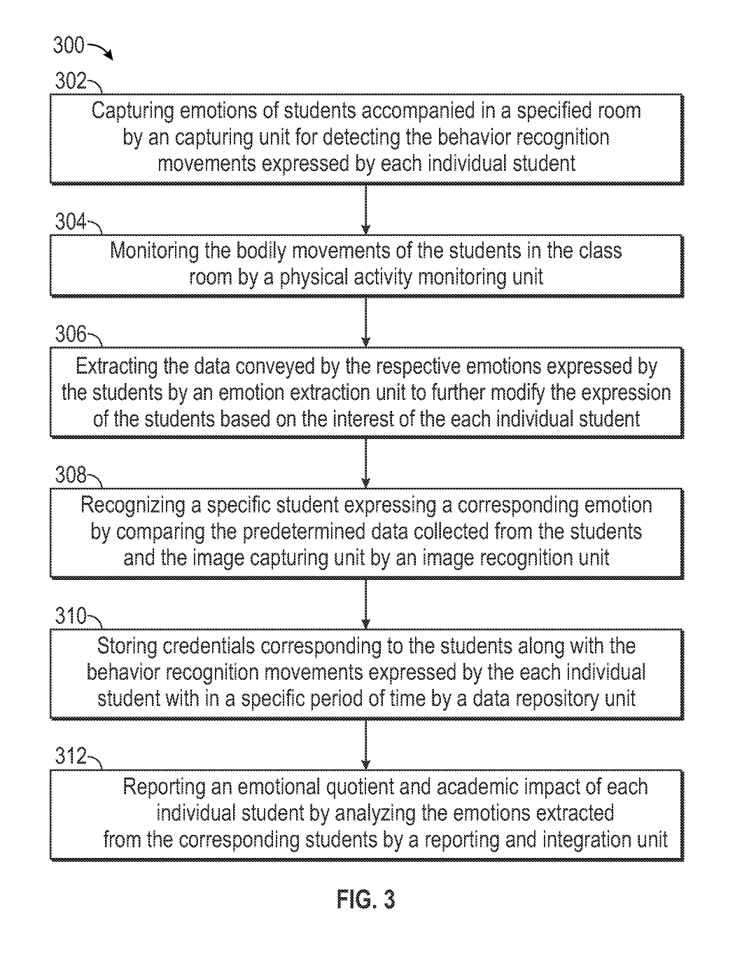

FIG. 3 is a flow diagram 300 depicting a method of recognizing behaviors. According to a non limiting exemplary embodiment of the present disclosure, the method of recognizing behaviors starts at step 302 by capturing emotions of students accompanied in a specified room by a capturing unit for detecting the behavior recognition movements expressed by each individual student. The capturing unit may be configured to capture the images of each individual student in the classroom, and then the captured images may be used to identify the emotions of the each individual student. Next at step 304 the physical activity monitoring unit may be configured to monitor the bodily movements of the students in the classroom for determining a temporary state of mind of the each individual student. Based on the captured behavior recognition movements of the capturing unit and monitored data of the physical activity monitoring unit are used for determining the behavior of the student at the particular time in the classroom.

As shown in FIG 3, at step 306, the data conveyed by the respective emotions expressed by the students is extracted by an emotion extraction unit to further modify the expression of the students based on the interest of the each individual student. Next at step 308, a specific student expressing a corresponding emotion is recognized by comparing with the predetermined data collected from the students and the image capturing unit by an image recognition unit, Further at step 310, the credentials corresponding to the students along with the behavior recognition movements expressed by the each individual student with a specific period of time are stored in a data repository unit and the analysis report corresponding to an emotional quotient and academic impact of each individual student is provided by a reporting and integration unit.

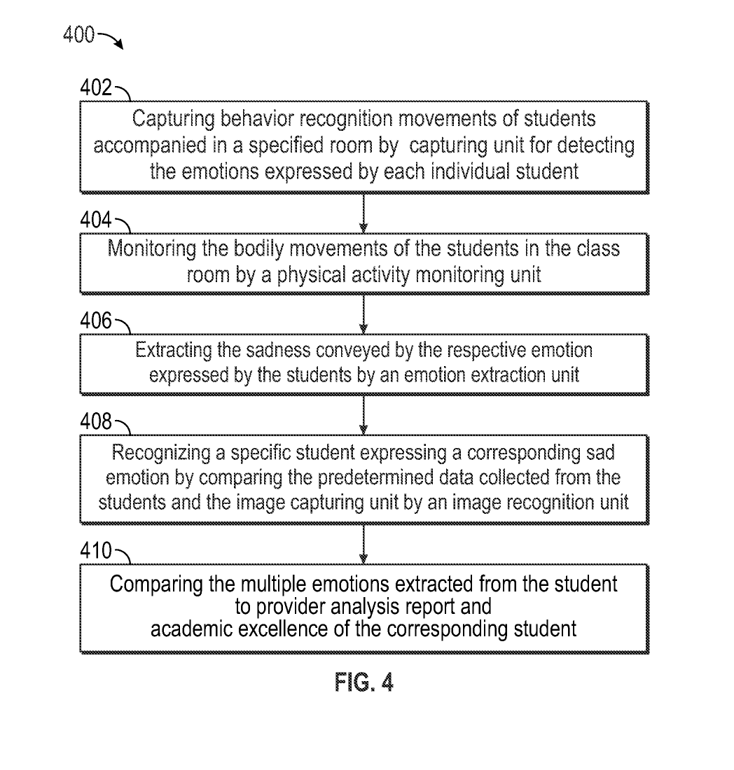

FIG. 4 is a flow diagram 400 depicting a. method of recognizing a sad emotion. According to a non limiting exemplary embodiment of the present disclosure, the method of recognizing behavior starts at 402 by capturing behavior recognition movements of students accompanied in a specified room by a capturing unit for detecting the respective sad emotion expressed by corresponding student. Next at step 404 the sad emotion expressed by the students is monitored by a physical activity monitoring unit for identifying the respective behavior recognition movements expressed by the corresponding student in a specific period of time.

As shown in FIG 4, at step 406, the sadness conveyed by the respective sad emotion expressed by the students is extracted by an emotion extraction unit to further modify the sad emotion of the student to the happy emotion based on the interest of the each individual student. Next at step 408, a specific student expressing a corresponding sad emotion is recognized by comparing with the predetermined data collected from the students and the image capturing unit by an image recognition unit. Further at step 410, the multiple feeling behavior recognition movements extracted from the student are compared to provide an analysis report and academic excellence of the corresponding student.

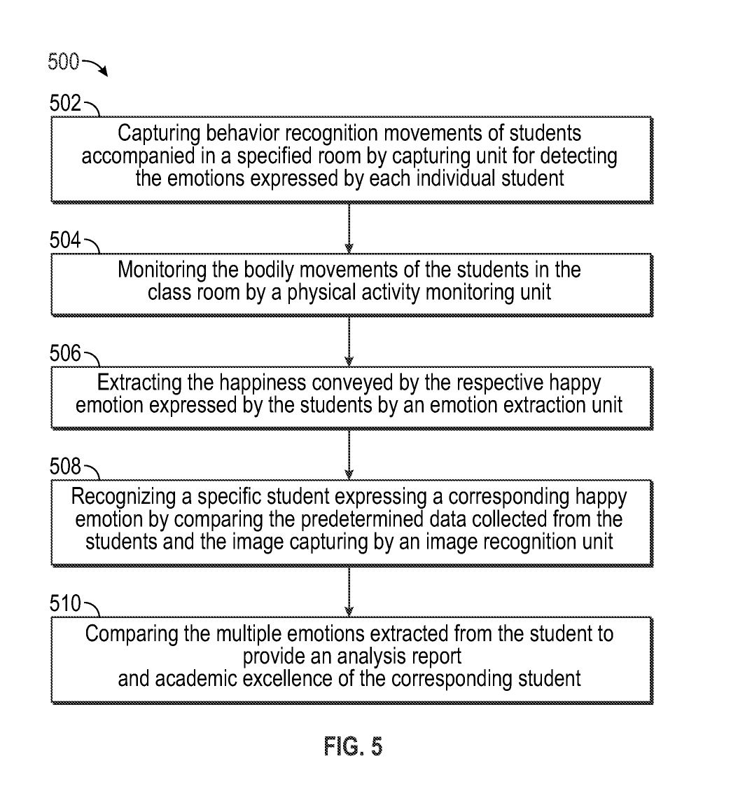

FIG. 5 is a flow diagram 500 depicting a method of recognizing a happy emotion. According to a non limiting exemplary embodiment of the present disclosure, the method of recognizing a behavior starts at step 502 by capturing behavior recognition movements of students accompanied in a specified room by a capturing unit for detecting the respective happy emotion expressed by corresponding student. Next at step 504 the happy emotion expressed by the students is monitored by a physical activity monitoring unit for identifying the respective behavior recognition movements of the body expressed by the corresponding student in a specific period of time.

As shown in FIG. 5, at step 506, the happiness feeling conveyed by the respective happy emotion expressed by the student is extracted by an emotion extraction unit to further maintain the same emotion of the student. Next at step 508, a specific student expressing a corresponding happy emotion is recognized by comparing with the predetermined data collected from the students and the image capturing unit by an image recognition unit. Further at step 510, the multiple behavior recognition movements extracted from the student are compared to provide an analysis report and academic excellence of the corresponding student.

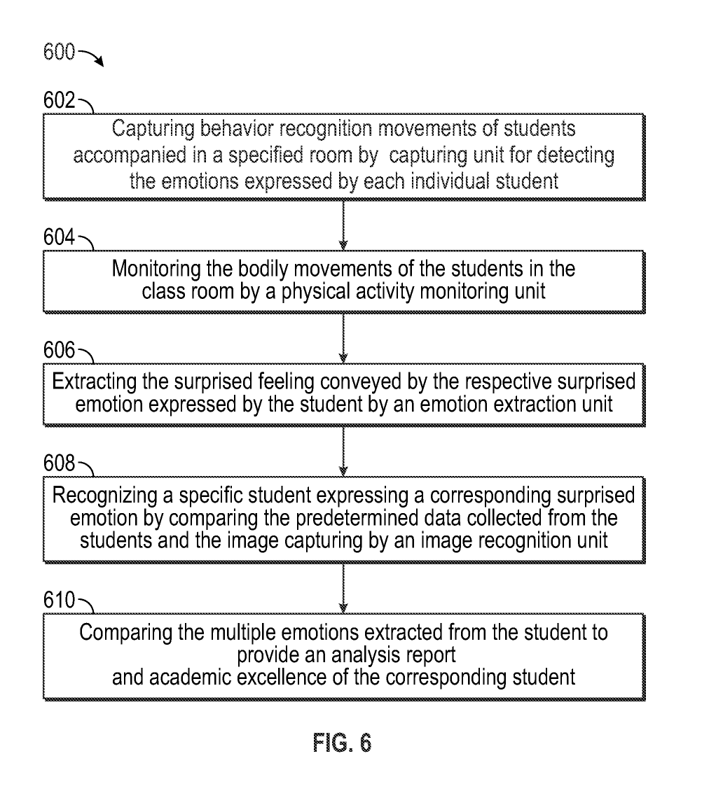

FIG. 6 is a flow diagram 600 depicting a method of recognizing a surprise emotion. According to a non limiting exemplary embodiment of the present disclosure, the method of recognizing a behavior starts at step 602 by capturing behavior recognition movements of students accompanied in a specified room by a capturing unit for detecting the respective surprise emotion expressed by corresponding student. Next at step 604 the surprise emotion expressed by the students is monitored by a physical activity monitoring unit for identifying the respective behavior recognition movements of the body expressed by the corresponding student in a specific period of time.

As shown in FIG. 6, at step 606, the surprise feeling conveyed by the respective surprise emotion expressed by the student is extracted by an emotion extraction unit to further maintain the same emotion in the student to provide an enthusiasm towards the lecture. Next at step 608, a specific student expressing a corresponding behavior recognition movements are recognized by comparing with the predetermined data collected from the students and the image capturing unit by an image recognition unit. Further at step 610, the multiple emotions extracted from the student are compared to provide an analysis report and academic excellence of the corresponding student.

Although the present invention has been described in terms of certain preferred embodiments and illustrations thereof, other embodiments and modifications to preferred embodiments may be possible that are within the principles and spirit of the invention. The above descriptions and figures are therefore to be regarded as illustrative and not restrictive.

Thus the scope of the present invention is defined by the appended claims and includes both combinations and sub combinations of the various features described herein above as well as variations and modifications thereof which would occur to persons skilled in the art upon reading the foregoing description.

1. A device comprising:
one or more capturing units configured to capture behavior recognition movements of one or more students accompanied in a specified area to detect one or more behavior recognition movements by each individual student, whereby the expressed one or more behavior recognition movements detected based on the plurality of body features collected from the one or more students;
one or more physical activity monitoring units configured to monitor one or more bodily movements for determining a temporary state of mind of the each individual student companied in the specified area;
an emotion extraction unit configured to extracts the data conveyed by the one or more behavior recognition movements expressed by the one or more students, whereby the extracted one or more behavior recognition movements used to further modify the expression of the one or more students based on the interest of the one or more students;
an image recognition unit configured to recognize a specific student expressing a emotion by comparing with the predetermined data collected from the one or more students; and the one or more emotion capturing units;
a data repository unit configured to store credentials of the one or more students along with the one or more behavior recognition movements expressed by the each individual student with a specific period of time; and
a reporting and integration unit configured to report the emotional quotient; and
academic impact of each individual student by analyzing the one or more behavior recognition movements extracted from the one or more students.

2. The device of claim 1, wherein the time tracked by the one or more capturing units configured to provide a specific time slice for the behavior recognition movements collected from the one or more students.

3. The device of claim 1, wherein the emotional quotient of the one or more students identified by the calculating the behavior recognition movements extracted time with the total detected time.

4. The device of claim 1, wherein the emotional quotient comprising trend analysis;
percentile analysis; benchmark analysis; and peer-group comparative analysis.

5. The device of claim 1, wherein the reporting and integration unit provides an academic impact by comparing the academic performance of the each individual student with the one or more emotions extracted from the one or more students.

6. The device of claim 1, wherein the one or more students interact with a. portable device through a wireless communication network.

7. The device of claim 1, wherein the one or more behavior recognition movements expressed by the one or more students detected for every predetermined period of time.

8. The device of claim 1, wherein the one or more physical activity monitoring units configured to track one or more eye blinks of each individual student for a predetermined period of time and compare the tracked data with the prior data provided by the one or more students for detecting autism of the respective student.

9. A method for detecting feelings recognize movements of the pupil, the method comprising:
capturing feelings behavior recognition movements of one or more students accompanied in a specified area by one or more capturing units and detect one or more behavior recognition movements expressed by each individual student, whereby the expressed one or more behavior recognition movements detected based on the plurality of body features collected from the one or more students;
monitoring one or more bodily movements of the one or more students by one or more physical activity monitoring units for determining a temporary state of mind of the each individual student. accompanied in the specified area;
extracting the data conveyed by the respective one or more behavior recognition movements expressed by the one or more students by an emotion extraction unit to further modify the expression of the one or more students based on the interest of the each individual student;
recognizing a specific student expressing a emotion by comparing the predetermined data collected from the one or more students and the image capturing unit by an emotion recognition unit;
storing credentials of the one or more students along with the one or more behavior recognition movements expressed by the each individual student within a specific period of time in a data repository unit; and
reporting an emotional quotient; and academic impact of each individual student by analyzing the one or more behavior recognition movements extracted from the one or more students by a reporting and integration unit.

10. The method of claim 9, further comprising a step of communicating with a server to dynamically upload the data received by the emotion recognition device.
